(19) United States
(12) Patent Application Publication
(10) Pub. No.: US 2025/0377708 A1
(43) Pub. Date: Dec. 11, 2025

(54) POWER OVERSUBSCRIPTION IN LLM CLOUD PROVIDERS

(71) Applicant: Microsoft Technology Licensing, LLC, Redmond, WA (US)

(72) Inventors: Esha CHOUKSE, Seattle, WA (US); Ricardo Gouvea BIANCHINI, Bellevue, WA (US); Brijesh WARRIER, Bellevue, WA (US); Chaojie ZHANG, Redmond, WA (US); Nithish MAHALINGAM, Campbell, CA (US); Inigo GOIRI PRESA, Bellevue, WA (US)

(21) Appl. No.: 18/740,499

(22) Filed: Jun. 11, 2024

(51) Int. Cl. G06F 1/3234; G06T 1/20

(52) U.S. Cl. CPC G06F 1/3234; G06T 1/20

(57) ABSTRACT

Systems and methods for implementing power oversubscription in graphic processing unit (GPU) servers are provided. An increase to a quantity of servers allocated to a group of GPU servers in an inference cluster is applied. Based on the power consumption of the group of GPU servers exceeding a first threshold, a frequency of low priority inference workloads is capped, and based on the power consumption of the group of GPU servers exceeding a second threshold, the frequency of the low priority inference workloads are capped and a frequency of high priority inference workloads are capped, enabling an increase in allocated server capacity in the existing inference clusters while maintaining service level objectives (SLOs).

### BACKGROUND

Recent innovation in large language models (LLMs), and their myriad use-cases have rapidly driven up the compute capacity demand for datacenter graphics processing units (GPUs). As such, datacenters and cloud providers face a massive GPU capacity crunch due to the explosion in demand for these LLMs.

To address the increasing demand, cloud providers and other enterprises have made substantial plans of growth in their datacenters to support these new workloads. Cloud providers have scaled up their clusters to use thousands of GPU servers and superclusters to train LLMs, and this demand is only growing for training newer and larger models, with the demand for inference being even larger than for training, constituting over most of the overall LLM compute cycles. To keep up, several enterprises are making large investments into building new GPU clusters to run LLM workloads. However, building new datacenters is expensive and carbon intensive. In addition, building new datacenters takes a long time which does not address the immediate demand.

While power, space, and cooling are three major bottlenecks in making datacenters denser, given the increasing model sizes of LLMs, LLMs are becoming increasingly power intensive. For example, datacenters are deployed with a fixed power budget, based on generators and contracts with the utility companies. Therefore, despite lower power utilization, adding more GPU servers to an existing datacenter would simply push the datacenter beyond the available power budget.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Example solutions for power oversubscription in graphic processing unit (GPU) clusters include: power oversubscription rules comprising a first threshold rule and a second threshold rule. The first threshold rule restricting low priority inference workloads from exceeding a first frequency level when a power consumption level exceeds a first threshold level. The second threshold rule restricts the low priority inference workloads from exceeding a second frequency level and restricting high priority inference workloads from exceeding a third frequency level. The second frequency level is lower than the first frequency level and the third frequency level is higher than the first frequency level. The solutions for the power oversubscription in the GPU clusters further include: receiving a power consumption level for a row of GPU servers, the row of GPU servers being part of an inference cluster of servers, determining whether the power consumption level exceeds the second threshold level, upon determining the power consumption exceeds the second threshold level, capping the lower priority inference workloads to the second frequency level, and upon determining the power consumption does not exceed the second threshold level, determining whether the power consumption exceeds the first threshold level, and upon determining the power consumption exceeds the first threshold level, capping the lower priority inference workloads to the first frequency level.

### BRIEF DESCRIPTION OF THE DRAWINGS

The present description will be better understood from the following detailed description read considering the accompanying drawings, wherein:

FIG. 1 is a flow diagram illustrating an example of an LLM inference architecture;

FIG. 2 is a block diagram illustrating an example of a system for implementing and mitigating power oversubscription in graphic processing unit (GPU) clusters;

FIG. 3 is a flowchart illustrating an example method for implementing and mitigating power oversubscription in GPU clusters using the system of FIG. 2.

FIG. 4 illustrates an example computing apparatus as a functional block diagram.

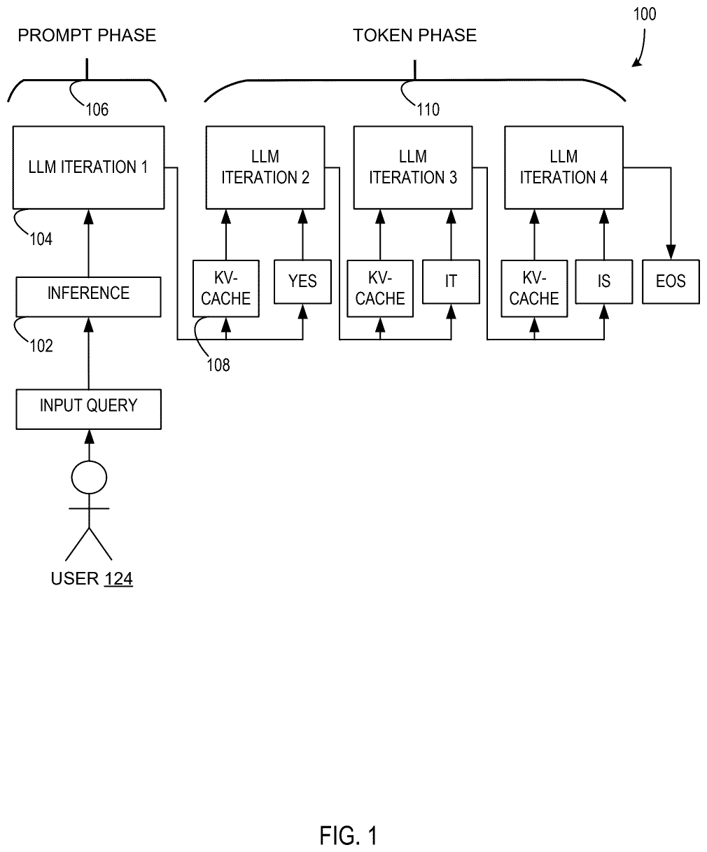

Corresponding reference characters indicate corresponding parts throughout the drawings. In FIGS. 1 to 4, the systems are illustrated as schematic drawings. The drawings may not be to scale. Any of the figures may be combined into a single example or embodiment.

### DETAILED DESCRIPTION

Aspects of the disclosure implement a power oversubscription framework for large language model (LLM) inference clusters. Given the effectiveness and limitations of existing graphics processing unit (GPU) frequency scaling and power capping for LLM inference and training, the examples described herein provide for safe and efficient power oversubscription in LLM clusters. As such, despite unreliable and slow out-of-band GPU power management interfaces and ever-changing models, the examples described herein increase allocated server capacity in existing inference clusters while maintaining service level objectives (SLOs).

Any changes to datacenter architectures would take many years to be available. Such solutions are impractical to support the current LLM demand. Our solution needs to work with existing infrastructure available today. For this, we need to be able to retrofit into the existing datacenters. The power and frequency capping are backstops to ensure that the UPS does not trip. Therefore, the path exercised to implement these need to be extremely reliable. Therefore, we need to avoid depending on the user or any unreliable code during the critical path for capping.

Power oversubscription can result in power overload, and therefore cannot be deployed safely without implementing mitigation mechanisms. This poses challenges for power oversubscription in GPU clusters. First, since LLM workloads are GPU intensive, existing central processing unit (CPU)-based power oversubscription techniques are ineffective in these clusters. Further, since LLMs are rapidly evolving, the efficacy of throttling in reducing power usage, and the impact on application performance is not well understood.

In addition, the number of additional racks added through power oversubscription is a static decision, that stays for the lifetime of the servers (e.g., 4-6 years). However, as the types of models and their use cases running in the cluster change with time, the policy for power capping needs to be configurable enough to support high performance for the workloads at most times, and avoid frequent power capping.

Furthermore, GPU power management poses its own set of challenges. GPUs do not expose the plethora of well-tailored power telemetry and control knobs that the CPU-based datacenters use to make cluster-level power throttling decisions. As such, datacenters need out-of-band mechanisms to communicate with the devices in a controlled and time-sensitive way. However, while out-of-band GPU power management interfaces do exist, they are slow and unreliable, which complicate safe power throttling.

Cloud providers can host LLMs in Virtual Machines (VMs) or as services. In these cases, GPUs are used in DDA mode, that precludes the cloud provider from accessing the GPU drivers. Reliable and fast power or frequency capping can be used as a fallback for power oversubscription, in case the overall power draw exceeds supported capacity. Although GPUs have fast in-band controls that allow the use of drivers for frequency and power capping, these are out of reach for the cloud provider. In addition, capping all workloads equally is unreasonable as latency-sensitive workloads should be prioritized over non-latency-sensitive workloads.

CPU servers can bring down the power of the entire server down by setting a single cap on the CPU; however, for GPU servers, where about 60% of the consumed power comes from GPUs, there are no fast controls available to bring the entire server power down by setting one cap. As such, due to the virtualization and Direct Device Access (DDA), any power controls need to be accessible out-of-band to be useful for cloud providers. With respect to GPUs, some systems offer controls that are helpful, but have limitations, such as frequency caps for the GPU compute. While frequency caps do not allow control of the GPU memory clock, frequency caps do allow control of the GPU compute clock. Another control that is offered by some systems is power caps at the GPU level, which allow capping the power consumed by individual GPUs. However, capping the individual GPUs does not guarantee spikes from breaching a desired level. Finally, some systems offer a power brake, which is a fast lever to bring the GPU down to almost a halt, stopping all progress.

Further, current datacenters host both inference and training in the same infrastructure. However, when managing power this is suboptimal due to the huge disparity between their at-scale characteristics. Power swings in large training jobs preclude power optimizations for inference. Further, when hosting virtual machines (VMs), cloud providers need to consider the peak power draw, which has a direct impact on the datacenter cost. This is especially important when building clusters for GPUs since they consume much higher power than regular compute machines. Further, LLM inference has two distinct phases, a prompt processing phase and a token sampling phase, each with very different profiles. While a prompt processing takes up a lot of power, token sampling does not. This makes it difficult to manage power for these workloads. For example, as the prompt phase is compute intensive, the power draw increases with the batch size. On the other hand, the token phase is memory bound and the power draw does not vary when increasing the number of tokens to process. Providers can cap the power usage of the VMs to reduce the peak power. However, the prompt phase is highly sensitive to the power cap and the latency increases substantially, while the token generation phase sees almost no impact in latency when power capping by over 50%.

FIG. 1 provides an illustrative example of a conventional generative LLM inference process the demonstrates the two phases (e.g., prompt and token phases). When a prompt query is received at 102, all input tokens are computed in parallel at 104, in a single iteration to generate a first token. This first phase is considered the prompt processing phase (e.g., a prompt phase 106). The context generated from attention layers during the prompt computation in the prompt phase 106 is saved in a KV-cache 108, since it is needed for all the future token generation iterations (e.g., LLM iterations 2, 3, and 4) in a token generation phase 110. After the first token is generated, the following tokens only use the last generated token and the KV-cache 108 as inputs to the forward pass of the model in the token generation phase 110. This makes the subsequent token generation more memory bandwidth and capacity intensive than the computationally heavy prompt phase.

Based on analyzing power consumption patterns and phases in LLMs, it is determined that there are specific properties in the workloads that would lead to low power utilization at the inference cluster level, despite high power utilization at the server-level. By observing the power utilization of LLM inference and training at the cluster level in production, it is determined that the power utilization does not peak to the level of the allocated power, despite individual servers peaking to their allocated power. Instead, LLM inference clusters utilize only up to 80% of the provisioned power, making them excellent candidates for power oversubscription. In contrast, LLM training clusters offer a smaller headroom (about 10%) since they incur in massive and coordinated power peaks due to large-scale synchronous training jobs. Aspects of the present disclosure safely oversubscribe the provisioned power in existing and upcoming multi-tenant GPU clusters to reduce costs and address the capacity crunch of running LLM workloads.

The disclosure operates in an unconventional manner at least by improving power efficiency of datacenters by power oversubscription in GPU clusters. Aspects of the disclosure are capable of utilizing the effectiveness and limitations of existing GPU frequency scaling and power capping for LLM inference and training. The systems and methods described herein provide safe and efficient power oversubscription in LLM clusters despite unreliable and slow out-of-band GPU power management interfaces and ever-changing models. The systems and methods described herein increase allocated server capacity by 30% in existing inference clusters, while maintaining the SLOs. This translates to an equivalent cost and carbon reduction due to building fewer datacenters, while promptly providing much needed cluster capacity to run additional LLM workloads.

Examples described herein are based on a characterization of the efficacy of GPU power capping and frequency scaling on modern LLM inference workloads. When looking at configurability and robustness to support changing LLMs over time, this is addressed with a double threshold solution, ensuring a safe time buffer before reaching peak cluster power utilization. Aspects of the present disclosure use two cluster-level power thresholds for frequency throttling based on the inference priority. The systems and methods described herein provide a robust, reliable power oversubscription framework for LLM inference clusters, which integrates with existing cluster-level power manager to boost allocated server capacity by 30% in existing inference GPU clusters, with minimal power throttling events and minimal performance loss. This improves power efficiency, reduces costs through fewer datacenters, and promptly meets demand for running additional LLM workloads.

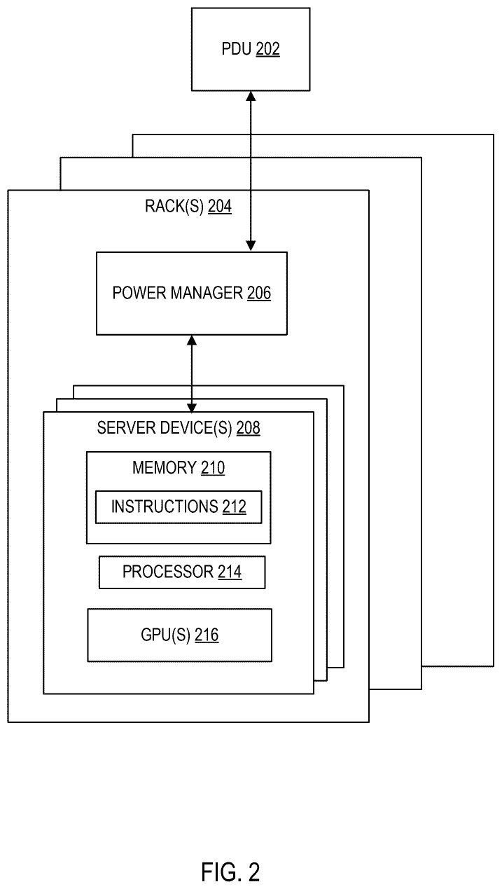

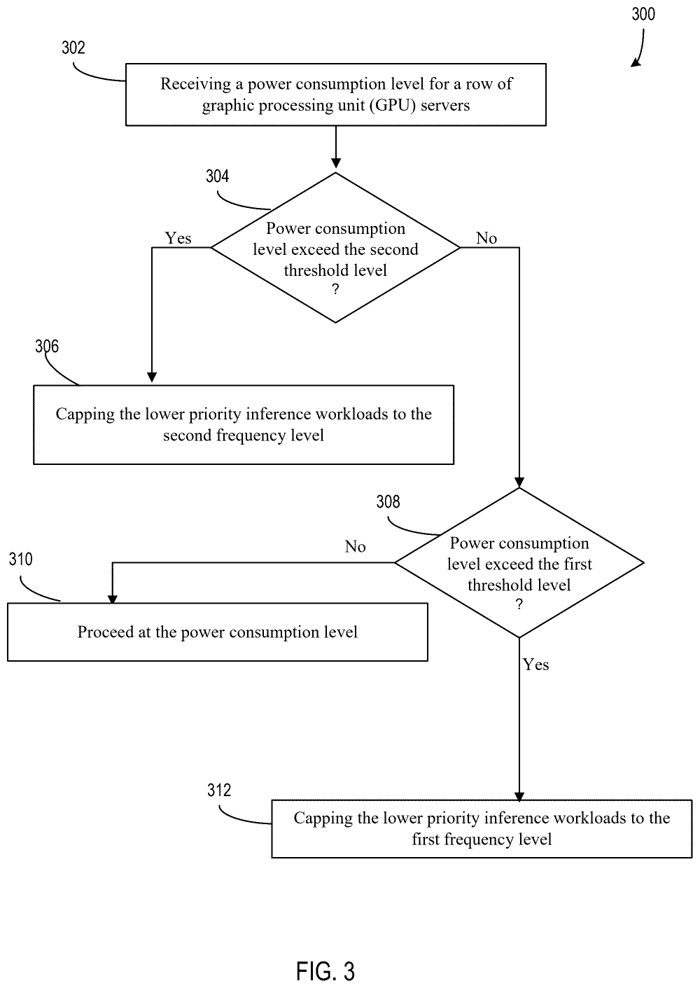

FIG. 2 is a block diagram illustrating an example system 200 for implementing power oversubscription in graphic processing unit (GPU) clusters. In some examples the system 100 includes a power distribution unit (PDU) 202, a plurality of racks 204, wherein each of the plurality of racks 204 includes a power manager 206, and a plurality of servers 208 comprising memory 210, a processor 214, and one or more GPUs 216. The PDU 202 manages and distributes electrical power to the server 208 as well as other networking equipment and devices. The memory 104 comprises computer executable instructions (e.g., instructions 212), that when executed by the processor 214, cause the processor to perform operations described herein with respect to FIG. 3.

In some examples, the power manager 206 runs at rack-level and receives frequent telemetry from the PDU 202 about row-level telemetry power. The power manager 204 has knowledge of a high priority and low priority inference workloads per VM. In some examples, the power manager 206 implements the mitigations mechanisms (e.g., the thresholds and caps as per the policy) for power oversubscription.

With respect to latency-sensitive workloads, some examples utilize two service-level priorities: high priority and low priority, with the low priority inference workloads being more probable to be capped. Table 1 illustrates an example distribution of the priorities between the types of services. The power manager 206 makes power-oversubscription aware decisions given the power manager understands not only the power telemetry, but also the various mix of high and low-priority jobs being assigned/executed in the rack 204.

TABLE 1

| Workload | Prompt Size | Output Size | Ratio | Priority |
|---|---|---|---|---|
| Summarize | 2048-8192 | 256-512 | 25% | Low |
| Search | 512-2048 | 1024-2048 | 25% | High |
| Chat | 2048-4096 | 128-2048 | 50% | 50:50 |

As explained above, there are distinct power usage patterns between the prompt and token phases in LLM inference. However, at a cluster-level, statistical multiplexing of these phases reduces the power utilization peaks lower. As such, a higher power aggregation is selected (e.g., a PDU breaker) as a capping decision point, which corresponds to a row of the racks 204.

In some examples, to provide guarantees against power trips, the system 200 uses only out-of-band interfaces that are available to the cloud providers from outside the VM. As such, any of the settings use can overwrite any other settings that the VM user asks for.

The main latency upper bound is imposed by the 10 s deadline from an uninterrupted power supply (UPSes). A PDU (e.g., the PDU 202) telemetry-based detection of a power threshold breach can be in the order of 3-5 s. Given that a GPU powerbrake takes 5 s to implement, the 10 s deadline is met from the UPSes. However, powerbrake substantially throttles workload performance since it brings down the frequency of all the GPUs to, for example, 288 MHz, and should only be used in dire situations. On the other hand, the less aggressive frequency and power caps take as long as 40 s to take effect. As such, some of the power oversubscription policies described herein use multiple power thresholds, while accounting for any power spikes that may happen within these 40 s.

The overall goal of the system 200 is to maximize additional servers (e.g., servers above an allocation), deployed using power oversubscription, while meeting the SLOs. For example, two power thresholds are used as shown in Table 2.

TABLE 1

| Mode | Low Priority | High Priority |
|---|---|---|
| Uncapped | Uncapped | Uncapped |
| Threshold T1 | Frequency Capped | Uncapped |
| | (1275 MHz) | |
| Threshold T2 | Frequency Capped | Frequency Capped |
| | (1110 MHz) | (1305 MHz) |
| Powerbreak | Frequency Capped | Frequency Capped |
| | (288 MHz) | (288 MHz) |

In some examples, a lower power threshold (e.g., Threshold T1) is used. IN some examples, the threshold T1 is only applicable to low priority inference workloads. Threshold T1 is used to execute objectives such as to sufficiently avoid capping high priority inference workloads, and to avoid capping the high priority inference workloads while maintaining the SLOs for the low priority inference workloads. As explained above, prompt phase has high power peaks, while token phase does not. As such, a power cap only impacts the prompt phase, whereas a frequency cap reduces the power in both the prompt and token phases. In some examples, to maximize the power savings from capping low priority inference workloads, a frequency capping for T1 is selected. In some examples, upon reaching the threshold T1, all the low priority inference workloads are set to the base frequency (the minimum promised frequency) of the particular GPU being used. For example, 1275 MHz.

In some examples, a second threshold (Threshold T2) is used as an upper power threshold. The Threshold T2 is chosen to avoid powerbrakes completely. As such, in some examples, the observed value of maximum power spike in 40 s is used to choose this threshold. When the threshold T2 is breached, all of the low priority inference workloads are frequency capped down to 1110 MHz. In some examples, when the consumption power is still above the threshold T2 after a predefined period of time, the high priority inference workloads are capped down to 1305 MHz frequency, to incur negligible performance impact while still reclaiming power.

In some examples, the power oversubscription policies need to be released/undone, and as such, the capped frequencies need to be uncapped in certain situations. However, to build in a hysteresis and to avoid constant capping/uncapping and overwhelm the power manager 206, uncapped thresholds are used. In some examples, an uncap threshold is 5% below a corresponding capping threshold of the threshold T1 or the threshold T2.

With reference now to FIG. 3, a flowchart illustrating an example method 300 for a hybrid summarization workflow is provided. In some examples, the method 600 is executed or otherwise performed by or in association with a system such as system 100 of FIG. 1.

At 302, a power consumption level for a row of GPU servers is received. In some examples, the row of GPU servers is part of an inference cluster of servers. In some examples, the GPUs within the GPU servers are used in DDA mode. As such the cloud provider is precluded from accessing the GPU drivers (e.g., in-band is not possible) and as such, only out-of-band interfaces are used to enforce policies in the power oversubscription mechanisms. In some examples, a memory (e.g., the memory 210) stores power oversubscription rules. In some examples, the power oversubscription rules include a first threshold rule and a second threshold rule. The first threshold rule restricts low priority inference workloads from exceeding a first frequency level when a power consumption level exceeds a first threshold level. The second threshold rule restricts the low priority inference workloads from exceeding a second frequency level and also restricts high priority inference workloads from exceeding a third frequency level. In some examples, the second frequency level is lower than the first frequency level and the third frequency level is higher than the first frequency level.

At 304, it is determined whether the power consumption level exceeds a second threshold level. At 306, when it is determined that the power consumption level exceeds the second threshold level, the lower priority inference workloads are capped to the second frequency level. In some examples, upon determining the power consumption exceeds the second threshold level, the higher priority inference workloads are capped to the third frequency level. As such, in this example, a frequency of both the low priority inference workloads and the high priority inference workloads are capped at the same time or substantially the same time. In another example, prior to capping the higher priority inference workloads upon determining the power consumption exceeds the second threshold level, the power manager 206 first determines whether the power consumption level as dropped since capping the frequency of the low priority inference workloads to the second frequency threshold. In this example, if the power consumption level has dropped or has dropped a defined amount (e.g., a threshold amount), the higher priority inference workloads are not capped as capping the low priority inference workloads are reducing the power consumption sufficiently without the need to cap the higher priority inference workloads as well. In some examples, the amount of drop in the power consumption level is defined by a user/administrator.

At 308, when it is determined that the power consumption level does not exceed the second threshold level, it is determined whether the power consumption exceeds the first threshold level. At 310, when it is determined that the power consumption level does not exceed the first threshold level, the system (e.g., the system 200) proceeds with the (current) power consumption and neither the low priority inference workloads nor the high priority inference workloads have a frequency capped.

At 312, when it is determined that the power consumption level does exceed the first threshold level, the lower priority inference workloads are capped to the first frequency level. Further, when it is determined that the power consumption level does exceed the first threshold levels, a frequency for the high priority inference workloads is not capped, and as such, only the frequency for the low priority inference workloads is capped.

### Exemplary Operating Environment

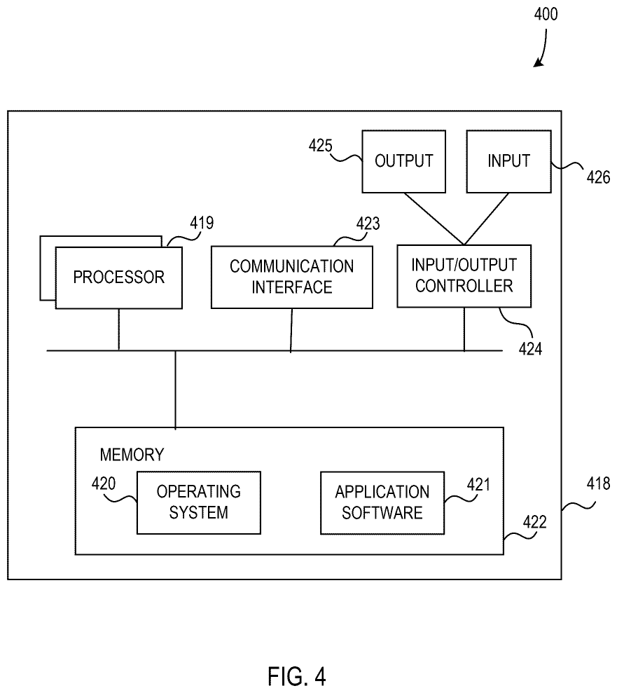

The present disclosure is operable with a computing apparatus according to an embodiment as a functional block diagram 400 in FIG. 4. In an example, components of a computing apparatus 418 (e.g., a server) are implemented as a part of an electronic device according to one or more embodiments described in this specification. The computing apparatus 418 comprises one or more processors 419 which may be microprocessors, controllers, or any other suitable type of processors for processing computer executable instructions to control the operation of the electronic device. Alternatively, or in addition, the processor 419 is any technology capable of executing logic or instructions, such as a hard-coded machine. In some examples, platform software comprising an operating system 420 or any other suitable platform software is provided on the apparatus 418 to enable application software 421 to be executed on the device.

In some examples, computer executable instructions are provided using any computer-readable media that is accessible by the computing apparatus 418. Computer-readable media include, for example, computer storage media such as a memory 422 and communications media. Computer storage media, such as a memory 422, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 422) is shown within the computing apparatus 418, it will be appreciated by a person skilled in the art, that, in some examples, the storage is distributed or located remotely and accessed via a network or other communication link (e.g., using a communication interface 423).

Further, in some examples, the computing apparatus 418 comprises an input/output controller 424 configured to output information to one or more output devices 425, for example a display or a speaker, which are separate from or integral to the electronic device. Additionally, or alternatively, the input/output controller 424 is configured to receive and process an input from one or more input devices 426, for example, a keyboard, a microphone, or a touchpad. In one example, the output device 425 also acts as the input device. An example of such a device is a touch sensitive display. The input/output controller 424 may also output data to devices other than the output device, e.g., a locally connected printing device. In some examples, a user provides input to the input device(s) 426 and/or receives output from the output device(s) 425.

The functionality described herein can be performed, at least in part, by one or more hardware logic components. According to an embodiment, the computing apparatus 418 is configured by the program code when executed by the processor 419 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory storing a first threshold rule and a second threshold rule, the first threshold rule restricting low priority inference workloads from exceeding a first frequency level when a power consumption level exceeds a first threshold level, the second threshold rule restricting the low priority inference workloads from exceeding a second frequency level and selectively restricting high priority inference workloads from exceeding a third frequency level, wherein the second frequency level is lower than the first frequency level and the third frequency level is higher than the first frequency level, the memory further comprising computer-executable instructions that, when executed by the processor, cause the processor to perform the following operations: receiving a power consumption level for a row of graphic processing unit (GPU) servers, the row of GPU servers being part of an inference cluster of servers; determining whether the power consumption level exceeds the second threshold level; upon determining the power consumption exceeds the second threshold level, capping the lower priority inference workloads to the second frequency level; and upon determining the power consumption does not exceed the second threshold level, determining whether the power consumption exceeds the first threshold level; and upon determining the power consumption exceeds the first threshold level, capping the lower priority inference workloads to the first frequency level.

An example computerized method for implementing power oversubscription rules is provided. The power oversubscription rules include a first threshold rule and a second threshold rule, the first threshold rule restricting low priority inference workloads from exceeding a first frequency level when a power consumption level exceeds a first threshold level, the second threshold rule restricting the low priority inference workloads from exceeding a second frequency level and restricting high priority inference workloads from exceeding a third frequency level, wherein the second frequency level is lower than the first frequency level and the third frequency level is higher than the first frequency level, the method comprising: receiving a power consumption level for a row of graphic processing unit (GPU) servers, the row of GPU servers being part of an inference cluster of servers; determining whether the power consumption level exceeds the second threshold level; upon determining the power consumption exceeds the second threshold level, capping the lower priority inference workloads to the second frequency level; and upon determining the power consumption does not exceed the second threshold level, determining whether the power consumption exceeds the first threshold level; and upon determining the power consumption exceeds the first threshold level, capping the lower priority inference workloads to the first frequency level.

An example computer-readable medium comprising computer-executable instructions for implementing power oversubscription rules is provided. The power oversubscription rules include a first threshold rule and a second threshold rule, the first threshold rule restricting low priority inference workloads from exceeding a first frequency level when a power consumption level exceeds a first threshold level, the second threshold rule restricting the low priority inference workloads from exceeding a second frequency level and restricting high priority inference workloads from exceeding a third frequency level, wherein the second frequency level is lower than the first frequency level and the third frequency level is higher than the first frequency level, the computer-executable instructions, when executed by the processor, cause the processor to perform the following operations: receiving a power consumption level for a row of graphic processing unit (GPU) servers, the row of GPU servers being part of an inference cluster of servers; determining whether the power consumption level exceeds the second threshold level; upon determining the power consumption exceeds the second threshold level, capping the lower priority inference workloads to the second frequency level; and upon determining the power consumption does not exceed the second threshold level, determining whether the power consumption exceeds the first threshold level; and upon determining the power consumption exceeds the first threshold level, capping the lower priority inference workloads to the first frequency level.

Alternatively, or in addition to the other examples described herein, examples include any combination of the following:
wherein GPUs within the GPU servers are used in direct device access (DDA) mode.
wherein the high priority inference workloads are not capped upon determining the power consumption exceeds the first threshold level.
further comprising upon determining the power consumption exceeds the second threshold level, capping the higher priority inference workloads to the third frequency level.
further comprising upon determining the power consumption is a threshold percentage below the second threshold level, uncapping the lower priority inference workloads and the higher priority inference workloads from the second frequency level.
further comprising: after uncapping the lower priority inference workloads and the higher priority inference workloads from the second frequency level, determining whether the power consumption level exceeds the first threshold level; and upon determining the power consumption exceeds the first threshold level, capping the lower priority inference workloads to the first frequency level without capping the higher priority inference workloads.
further comprising: after uncapping the lower priority inference workloads and the higher priority inference workloads from the second frequency level, determining whether the power consumption level exceeds the first threshold level; and upon determining the power consumption does not exceed the first threshold level, determine not to cap either the low priority inference workloads or the high priority inference workloads. receive power consumption level for a row of graphic processing unit (GPU) servers, the row of GPU servers being part of an inference cluster of servers; determining whether the power consumption level exceeds the second threshold level; upon determining the power consumption exceeds the second threshold level, capping the lower priority inference workloads to the second frequency level; and upon determining the power consumption does not exceed the second threshold level, determining whether the power consumption exceeds the first threshold level; and upon determining the power consumption exceeds the first threshold level, capping the lower priority inference workloads to the first frequency level.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory storing a first threshold rule and a second threshold rule, the first threshold rule restricting low priority inference workloads from exceeding a first frequency level when a power consumption level exceeds a first threshold level, the second threshold rule restricting the low priority inference workloads from exceeding a second frequency level and selectively restricting high priority inference workloads from exceeding a third frequency level, wherein the second frequency level is lower than the first frequency level and the third frequency level is higher than the first frequency level, the memory further comprising computer-executable instructions that, when executed by the processor, cause the processor to perform the following operations:
receiving a power consumption level for a row of graphic processing unit (GPU) servers, the row of GPU servers being part of an inference cluster of servers;
determining whether the power consumption level exceeds the second threshold level;
upon determining the power consumption level exceeds the second threshold level, capping the lower priority inference workloads to the second frequency level; and
upon determining the power consumption level does not exceed the second threshold level, determining whether the power consumption level exceeds the first threshold level; and
upon determining the power consumption level exceeds the first threshold level, capping the lower priority inference workloads to the first frequency level.

2. The system of claim 1, wherein GPUs within the GPU servers are used in direct device access (DDA) mode.

3. The system of claim 1, wherein the high priority inference workloads are not capped upon determining the power consumption level exceeds the first threshold level.

4. The system of claim 3, wherein the computer-executable instructions further cause the processor to perform the following operations: upon determining the power consumption level exceeds the second threshold level, capping the higher priority inference workloads to the third frequency level.

5. The system of claim 4, wherein the computer-executable instructions further cause the processor to perform the following operations: upon determining the power consumption level is a threshold percentage below the second threshold level, uncapping the lower priority inference workloads and the higher priority inference workloads from the second frequency level.

6. The system of claim 5, wherein the computer-executable instructions further cause the processor to perform the following operations:
after uncapping the lower priority inference workloads and the higher priority inference workloads from the second frequency level, determining whether the power consumption level exceeds the first threshold level; and
upon determining the power consumption level exceeds the first threshold level, capping the lower priority inference workloads to the first frequency level without capping the higher priority inference workloads.

7. The system of claim 5, wherein the computer-executable instructions further cause the processor to perform the following operations:
after uncapping the lower priority inference workloads and the higher priority inference workloads from the second frequency level, determining whether the power consumption level exceeds the first threshold level; and
upon determining the power consumption level does not exceed the first threshold level, determine not to cap either the low priority inference workloads or the high priority inference workloads.

8. A computerized method for implementing power oversubscription rules, the power oversubscription rules comprising a first threshold rule and a second threshold rule, the first threshold rule restricting low priority inference workloads from exceeding a first frequency level when a power consumption level exceeds a first threshold level, the second threshold rule restricting the low priority inference workloads from exceeding a second frequency level and restricting high priority inference workloads from exceeding a third frequency level, wherein the second frequency level is lower than the first frequency level and the third frequency level is higher than the first frequency level, the method comprising:
receiving a power consumption level for a row of graphic processing unit (GPU) servers, the row of GPU servers being part of an inference cluster of servers;
determining whether the power consumption level exceeds the second threshold level;
upon determining the power consumption level exceeds the second threshold level, capping the lower priority inference workloads to the second frequency level; and
upon determining the power consumption level does not exceed the second threshold level, determining whether the power consumption exceeds the first threshold level; and
upon determining the power consumption level exceeds the first threshold level, capping the lower priority inference workloads to the first frequency level.

9. The method of claim 8, wherein GPUs within the GPU servers are used in direct device access (DDA) mode.

10. The method of claim 8, wherein the high priority inference workloads are not capped upon determining the power consumption level exceeds the first threshold level.

11. The method of claim 10, further comprising upon determining the power consumption level exceeds the second threshold level, capping the higher priority inference workloads to the third frequency level.

12. The method of claim 11, further comprising upon determining the power consumption level is a threshold percentage below the second threshold level, uncapping the lower priority inference workloads and the higher priority inference workloads from the second frequency level.

13. The method of claim 12, further comprising:
after uncapping the lower priority inference workloads and the higher priority inference workloads from the second frequency level, determining whether the power consumption level exceeds the first threshold level; and
upon determining the power consumption level exceeds the first threshold level, capping the lower priority inference workloads to the first frequency level without capping the higher priority inference workloads.

14. The method of claim 12, further comprising:
after uncapping the lower priority inference workloads and the higher priority inference workloads from the second frequency level, determining whether the power consumption level exceeds the first threshold level; and
upon determining the power consumption level does not exceed the first threshold level, determine not to cap either the low priority inference workloads or the high priority inference workloads. receive power consumption level for a row of graphic processing unit (GPU) servers, the row of GPU servers being part of an inference cluster of servers;
determining whether the power consumption level exceeds the second threshold level;
upon determining the power consumption level exceeds the second threshold level, capping the lower priority inference workloads to the second frequency level; and
upon determining the power consumption level does not exceed the second threshold level, determining whether the power consumption level exceeds the first threshold level; and
upon determining the power consumption level exceeds the first threshold level, capping the lower priority inference workloads to the first frequency level.

15. A computer-readable medium comprising computer-executable instructions for implementing power oversubscription rules, the power oversubscription rules comprising a first threshold rule and a second threshold rule, the first threshold rule restricting low priority inference workloads from exceeding a first frequency level when a power consumption level exceeds a first threshold level, the second threshold rule restricting the low priority inference workloads from exceeding a second frequency level and restricting high priority inference workloads from exceeding a third frequency level, wherein the second frequency level is lower than the first frequency level and the third frequency level is higher than the first frequency level, the computer-executable instructions, when executed by a processor, cause the processor to perform the following operations:
receiving a power consumption level for a row of graphic processing unit (GPU) servers, the row of GPU servers being part of an inference cluster of servers;
determining whether the power consumption level exceeds the second threshold level;
upon determining the power consumption level exceeds the second threshold level, capping the lower priority inference workloads to the second frequency level; and
upon determining the power consumption level does not exceed the second threshold level, determining whether the power consumption exceeds the first threshold level; and
upon determining the power consumption level exceeds the first threshold level, capping the lower priority inference workloads to the first frequency level.

16. The computer-readable medium of claim 15, wherein GPUs within the GPU servers are used in direct device access (DDA) mode.

17. The computer-readable medium of claim 15, wherein the high priority inference workloads are not capped upon determining the power consumption level exceeds the first threshold level.

18. The computer-readable medium of claim 17, wherein the computer-executable instructions further cause the processor to perform the following operations: upon determining the power consumption level exceeds the second threshold level, capping the higher priority inference workloads to the third frequency level.

19. The computer-readable medium of claim 18, wherein the computer-executable instructions further cause the processor to perform the following operations: determining the power consumption level is a threshold percentage below the second threshold level, uncapping the lower priority inference workloads and the higher priority inference workloads from the second frequency level.

20. The computer-readable medium of claim 18, wherein the computer-executable instructions further cause the processor to perform the following operations:
after uncapping the lower priority inference workloads and the higher priority inference workloads from the second frequency level, determining whether the power consumption level exceeds the first threshold level; and
upon determining the power consumption exceeds the first threshold level, capping the lower priority inference workloads to the first frequency level without capping the higher priority inference workloads.
